(19) United States
(12) Patent Application Publication
(10) Pub. No.: US 2026/0285227 A1
(43) Pub. Date: Sep. 24, 2026

(54) MIRROR SUPPORT AND MIRROR ASSEMBLY HAVING SAME

(71) Applicant: LG ELECTRONICS INC., Seoul (KR)

(72) Inventor: Kiman SONG, Seoul (KR)

(73) Assignee: LG ELECTRONICS INC., Seoul (KR)

(21) Appl. No.: 18/881,080

(22) PCT Filed: Jul. 6, 2022
(86) PCT No.: PCT/KR2022/009767

§ 371 Date: Jan. 3, 2025

(51) Int. Cl. B60R 1/04; B60R 1/12

(52) U.S. Cl. CPC B60R 1/04; B60R 1/12

(57) ABSTRACT

The present embodiment may comprise: a ball shaft in which a pair of balls are connected by a shaft; a pair of ball housings in which a ball receiving portion for receiving the balls is formed and a spring support portion is formed; and a pair of springs supported on the spring support portion and pressing the balls into the ball receiving portion.

### TECHNICAL FIELD

The present disclosure relates to a mirror support for supporting a mirror and a mirror assembly having the same.

### Background Art

An example of a mirror support may be a room mirror support that supports a room mirror used in a vehicle, and such a mirror support may be fixed to a glass or roof panel of the vehicle and may adjust the angle of the room mirror.

In U.S. Patent Publication No. US8201800B2 (Jun. 19, 2012), a rearview mirror assembly is disclosed, and the rearview mirror assembly comprises a receiver having a plurality of fingers defining a ball accommodation area, at least one pivot ball disposed in the ball accommodation area of the receiver, and a spring forming a circle and disposed around the fingers of the receiver.

### DISCLOSURE

### Technical Problem

An object of the present embodiment is to provide a mirror support having a simple structure and easy assembly, and a mirror assembly having the same.

### Technical Solution

A mirror assembly according to the present embodiment may comprise a mirror and a mirror support supporting the mirror.

A mirror support may comprise a ball shaft in which a pair of balls is connected by a shaft; a pair of ball housings having a ball accommodation portion to accommodate the balls and having a spring supporting portion; and a pair of springs supported on the spring supporting portion and pressing the ball into the ball accommodation portion.

The mirror may comprise a mirror housing; a panel body disposed in front of the mirror housing; a display panel disposed inside the panel body; and a fixing bracket accommodated in the mirror housing and to which one of the pair of ball housings is fastened.

The mirror may comprise a main-PCB; and a sub-PCB disposed at the rear of the main-PCB.

The first distance between the main-PCB and the sub-PCB may be shorter than the second distance between the main PC and a front end of the mirror.

The first distance of the mirror may be shorter than a third distance between the sub-PCB and a rear end of the mirror.

The ball housing may have an insertion portion communicating with the inside of the ball accommodation portion and into which the ball shaft is inserted.

The spring may comprise an elastic portion that comes into contact with the ball, and a mounting portion that is bent at an end part of the elastic portion and inserted into the spring supporting portion and supported by the spring supporting portion.

The ball accommodation portion may comprise a curved surface that makes surface contact with the ball.

The ball accommodation portion may comprise a through-part through which the ball shaft passes.

A pair of ball housings may comprise a housing mirror coupled to a mirror; and a housing glass attached to the glass.

A pair of springs may comprise a first spring supported on a spring supporting portion of the housing mirror and pressurizing one of the pair of balls into the ball accommodation portion of the housing mirror; and a second spring supported on a spring supporting portion of the housing glass and pressing the other of the pair of balls into the ball accommodation portion of the housing glass.

One of the housing mirror and ball shaft may be made of metal and the other is made of plastic.

One of the housing glass and ball shaft may be made of metal and the other is made of plastic.

The mirror support may further comprise a wire connector disposed in the housing glass; and a wire connected to the wire connector, in which the wire may comprise a separation portion spaced apart from the shaft.

The mirror support may further comprise a cover shielding the gap between the separation portion and the shaft.

### Advantageous Effect

According to this embodiment, an insertion portion is formed in the ball housing that communicates with the interior of the ball accommodation portion and into which a ball shaft is inserted, so that shaft assembly can be simplified.

In addition, since one of the housing mirror and the ball shaft is made of metal and the other is made of plastic, there is no need to install a separate finger socket for friction between the housing mirror and the ball shaft, which minimizes the number of parts and reduces material costs.

In addition, since one of the housing glass and the ball shaft is made of metal and the other is made of plastic, there is no need to install a separate finger socket for friction between the housing glass and the ball shaft, which minimizes the number of parts and reduces material costs.

In addition, the assembly process can be simplified as the spring can be mounted by simply inserting the spring into the housing mirror or housing glass.

In addition, the first spring can maintain friction between the housing mirror and the ball shaft and reliably support the mirror.

In addition, the second spring can maintain friction between the housing glass and the ball shaft, and reliably support the mirror and ball shaft.

### DESCRIPTION OF DRAWINGS

FIG. 1 is a perspective view illustrating a mirror assembly according to the present embodiment,

FIG. 2 is a cross-sectional view illustrating a mirror assembly according to the present embodiment,

FIG. 3 is a view illustrating an example of a mirror support according to the present embodiment,

FIG. 4 is an exploded perspective view illustrating an example of a mirror support according to the present embodiment,

FIG. 5 is a front view illustrating the assembly process of a ball shaft and a ball housing according to the present embodiment,

FIG. 6 is a side view illustrating the assembly process of the ball shaft and ball housing according to the present embodiment,

FIG. 7 is a cross-sectional view illustrating a spring mounting process according to the present embodiment,

FIG. 8 is an exploded perspective view illustrating a mirror according to the present embodiment,

FIG. 9 is a rear view illustrating a mirror according to the present embodiment,

FIG. 10 is a plan view illustrating the interior of a mirror according to the present embodiment,

FIG. 11 is a side view illustrating another example of a mirror support according to the present embodiment,

FIG. 12 is a cross-sectional view illustrating another example of a mirror support according to the present embodiment,

FIG. 13 is a side view illustrating a state where the cover illustrated in FIG. 11 is separated.

### BEST MODE

Hereinafter, specific embodiments of the present disclosure will be described in detail with reference to the drawings.

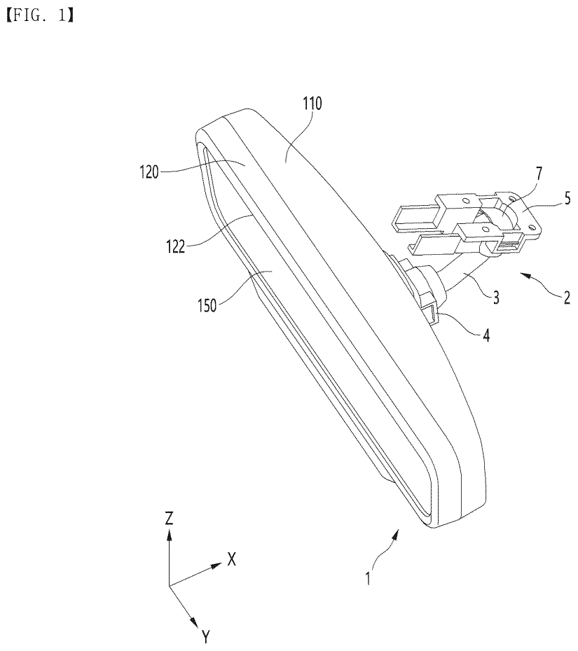

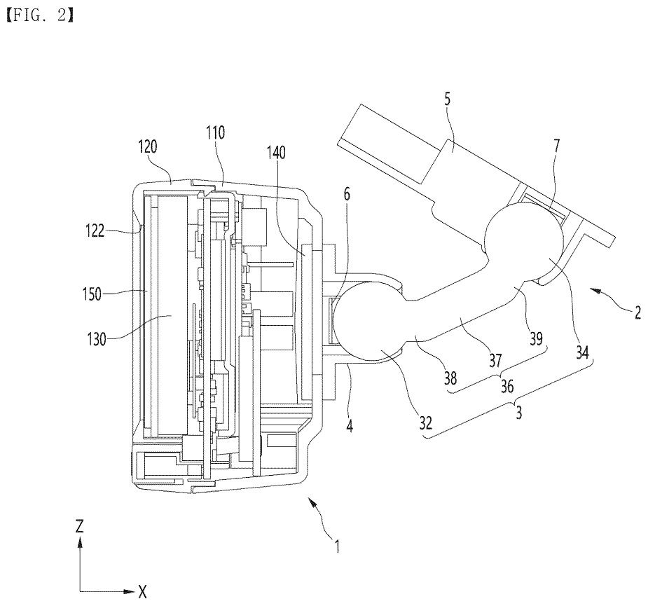

FIG. 1 is a perspective view illustrating a mirror assembly according to the present embodiment, and FIG. 2 is a cross-sectional view illustrating a mirror assembly according to the present embodiment

The mirror assembly may comprise a mirror 1 and a mirror support 2 that supports the mirror 1.

The mirror assembly can be installed in a vehicle to provide a rear view to the driver. An example of the mirror 1 may be a device to protect the driver's eyes from the lights of a following vehicle during night driving, and may be an ECM room mirror that detects light with a sensor installed in the mirror 1 and darkens the reflection of the mirror.

The mirror support 2 can be placed on the glass or roof panel of the vehicle and can support the mirror 1 so that the angle can be adjusted.

The mirror support 2 may comprise a ball shaft 3, a pair of ball housings 4, 5 and a pair of springs 6, 7.

The ball shaft 3 may have a pair of balls 32, 34 connected to a shaft 36. The pair of balls 32, 34 and the shaft 36 may be formed integrally.

A pair of balls 32, 34 may be formed at a longitudinal end part of a shaft 36. The pair of balls 32, 34 may be spaced apart with the shaft 36 therebetween. The pair of balls 32, 34 may be spaced apart in a front and rear direction X and the vertical direction Z. Each of the pair of balls 32, 34 may have an overall shape that is spherical or close to a spherical shape. The outer circumferential surface of each of the pair of balls 32, 34 may be curved.

The shaft 36 may be straight or bent and may support a pair of balls 32, 34 spaced apart from each other.

In a case where the shaft 36 has a bent shape, the shaft 36 may comprise, as illustrated in FIG. 2, a center shaft 37, a first bent part 38 connecting the center shaft 37 and one 32 (first ball) of the pair of balls 32, 34, and a second bent part 39 connecting the center shaft 37 and the other 34 (second ball) of the pair of balls 32, 34.

The center shaft 37 can be elongated in an inclined direction.

The first bent part 38 can extend approximately in the front and rear direction X from the rear end of the center shaft 37.

The second bent part 39 can extend in an inclined direction close to the vertical direction Z or in the vertical direction Z from the front end of the center shaft 37.

An imaginary line extending in the longitudinal direction of the first bent part 38 from the first bent part 38 and an imaginary line extending in the longitudinal direction of the second bent part 39 from the second bent part 39 may have an obtuse inclination angle.

A pair of balls 32, 34 may comprise a first ball 32 and a second ball 34 that are spaced apart from each other.

The first ball 32 can be supported on either 4 of a pair of ball housings 4, 5.

The second ball 34 can be supported on the other 5 of the pair of ball housings 4, 5.

A pair of ball housings 4, 5 may comprise a housing mirror 4 coupled to a mirror 1 and a housing glass 5 attached to the glass.

The housing mirror 4 and the housing glass 5 can each be connected to the ball shaft 3.

The housing mirror 4 and the housing glass 5 can be separated from each other by the ball shaft 3. The housing mirror 4 can be hung on the housing glass 5 by the ball shaft 3.

The first ball 32 can be accommodated in the housing mirror 4, and the housing mirror 4 can be rotated around the first ball 32.

The second ball 34 can be accommodated in the housing glass 5, and the ball shaft 3 can rotate around the second ball 34.

A pair of springs 6, 7 may comprise a first spring 6 and a second spring 7.

The first spring 6 can be coupled to the housing mirror 4 and can press the first ball 32 to the housing mirror 4.

The second spring 7 can be coupled to the housing glass 5 and press the second ball 34 to the housing glass 5.

The mirror 1 may comprise a mirror housing 110 and a panel body 120 positioned in front of the mirror housing 110. The mirror housing 110 and the panel body 120 may form a mirror casing that forms an outer appearance of the mirror 1.

The mirror housing 110 can form the outer appearance of the front surface of the mirror 1 and the outer appearance of a part of the peripheral surface thereof.

The panel body 120 can form the remaining outer surface of the peripheral surface of the mirror 1. The panel body 120 can have an opening 122 formed on the back surface.

The mirror 1 may further comprise a display panel 130. The display panel 130 may be placed inside the mirror casing. The display panel 130 may be placed inside the mirror housing 110 or may be placed inside the panel body 120. Hereinafter, the display panel 130 may be placed inside the panel body 120, and the panel body 120 may surround the peripheral surface of the display panel 130.

The mirror 1 may comprise a fixing bracket 140 to which a mirror support 2 is fastened.

The fixing bracket 140 can be accommodated in the mirror housing 110. The fixing bracket 40 can be fastened to one 4 of the pair of ball housings 4. The housing mirror 4 can be fastened to the fixing bracket 40. The housing mirror 4 can be fastened to the fixing bracket 140 by a fastening member such as a screw. The fastening member such as a screw can be fastened to the fixing bracket 140 by passing through a fastening hole formed in the housing mirror 40 and a fastening hole formed in the mirror housing 110.

The mirror 1 may comprise an ECM 150 (electronic chromic mirror) positioned at the rear of the display panel 130.

The ECM 150 may be a photosensitive mirror, and may be composed of two low-reflectivity mirrors and a high-reflectivity mirror which are overlapped with each other. The ECM 150 may also comprise a sensor that recognizes light. The ECM 150 may be in the shape of a plate or sheet as a whole.

The ECM 150 normally illuminates with a high-reflectivity mirror, but when strong light hits the sensor, the ECM can suppress the light reflection by using a low-reflectivity mirror.

The ECM 150 can be accommodated inside the panel body 120 and can be seen through the opening 122 of the panel body 120.

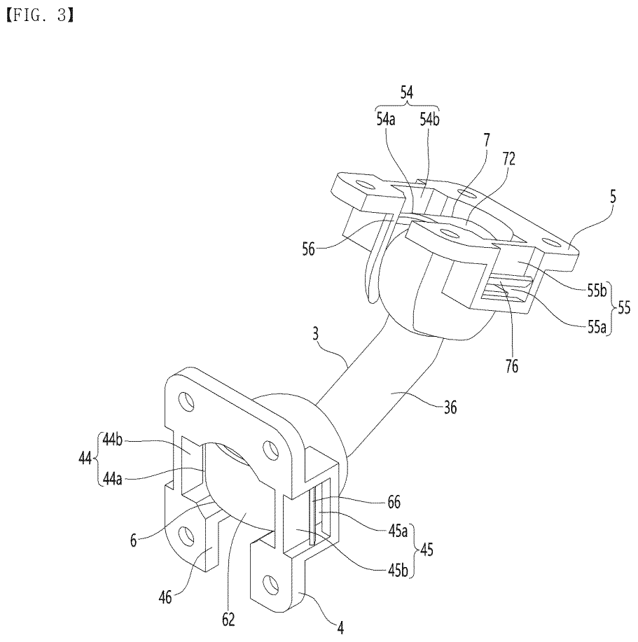

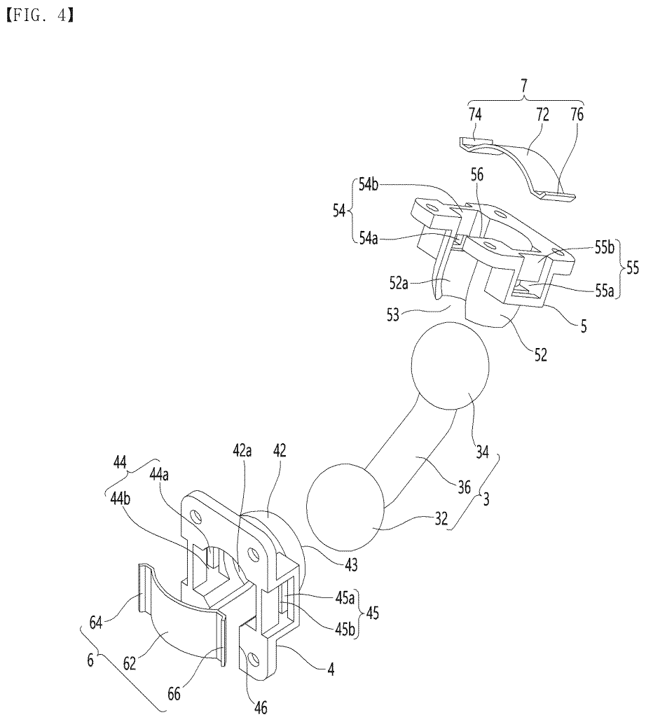

FIG. 3 is a view illustrating an example of a mirror support according to the present embodiment, and FIG. 4 is an exploded perspective view illustrating an example of a mirror support according to the present embodiment.

A pair of ball housings 4, 5 may comprise a ball accommodation portion in which a ball is accommodated. The ball accommodation portion may comprise a curved surface that makes surface contact with the ball. A pair of ball housings 4, 5 may comprise a spring supporting portion in which a spring 6, 7 is supported. The ball housings 4, 5 may have an insertion portion formed through which a ball shaft 3 is inserted. The insertion portion may pass through the ball accommodation portion.

The ball shaft 3 may comprise a ball 32, 34 accommodated inside a ball housing 4, 5 and a shaft 36 extending from the ball 32, 34 to the outside of the ball housing 4, 5.

The housing mirror 4 which is one of the pair of ball housing 4, 5 may comprise a first ball accommodation portion 42 in which a first ball 32 is accommodated. A ball accommodation space in which the first ball 32 is received may be formed inside the first ball accommodation portion 42. The housing mirror 4 may have an open rear surface. The first ball accommodation portion 42 may have a through-part formed through which a ball shaft 3 passes. The through-part may be formed at a front part of the housing mirror 4. The through-part may be open in the front and rear direction X.

The first ball accommodation portion 42 may comprise a first curved surface 42a that is in surface contact with the first ball 32. The first curved surface 42a may be formed on the inside of the first ball accommodation portion 42. The first curved surface 42a may be in surface contact with a part of the outer surface of the first ball 32.

A through-part 43 through which a ball shaft 3 passes may be formed in the first ball accommodation portion 42. The through-part 43 may be formed in the front part of the housing mirror 4. The through-part 53 may be an opening that is open in the front and rear direction X.

The housing mirror 4 may comprise at least one first spring supporting portion 44, 45 on which a first spring 6 is supported. The first spring supporting portion 44, 45 may comprise an opening into which a mounting portion of the first spring 6 is inserted, and may comprise a side wall on which the mounting portion of the first spring 6 is caught.

At least one first spring supporting portion 44, 45 may comprise a left supporting portion 44 formed on the left side of the housing mirror 4 and a right supporting portion 45 formed on the right side of the housing mirror 4.

The left supporting portion 44 may comprise a left opening 44a into which the left mounting portion 64 of the first spring 6 is inserted, and a left wall 44b on which the left mounting portion 64 of the first spring 6 is caught.

The right supporting portion 45 may comprise a right opening 45a into which the right mounting portion 66 of the first spring 6 is inserted, and a right wall 45b on which the right mounting portion 66 of the first spring 6 is caught.

The housing mirror 4 can have a ball shaft 3 inserted to form a first insertion portion 46. The first insertion portion 46 can communicate with the interior of the first ball accommodation portion 42.

The first insertion portion 46 may comprise an opening formed long in the vertical direction Z at the lower part of the housing mirror 4. The first insertion portion 46 may comprise an opening formed long in the front and rear direction X at the first ball accommodation portion 42. The width of the opening in the left and right direction may be smaller than the diameter of the first ball 32 and larger than the diameter of the shaft 36.

When the ball shaft 3 is mounted on the housing mirror 4, the shaft 36 can pass through the first insertion portion 46, and the first ball 42 can be inserted into and accommodated within the first ball accommodation portion 42.

The housing glass 5 which is other of the pair of ball housings 4, 5 may comprise a second ball accommodation portion 52 in which a second ball 34 is accommodated. A ball accommodation space in which the second ball 34 is accommodated may be formed inside the second ball accommodation portion 52. The housing glass 5 may have an open upper surface.

The second ball accommodation portion 52 may comprise a second curved surface 52a that makes surface contact with the second ball 34. The second curved surface 52a may be formed on the inside of the second ball accommodation portion 52. The second curved surface 52a may make surface contact with a part of the outer surface of the second ball 34.

A through-part 53 through which a ball shaft 3 passes may be formed in the second ball accommodation portion 52. The through-part 53 may be formed in the lower part of the housing glass 5. The through-part 53 may be an opening that is open in the vertical direction Z.

The housing glass 5 may comprise at least one second spring supporting portion 54, 55 on which a second spring 7 is supported. The second spring supporting portion 54, 55 may comprise an opening into which an end part of the second spring 7 is inserted, and may comprise a side wall on which an end part of the second spring 7 is caught.

At least one second spring supporting portion 54, 55 may comprise a left supporting portion 54 formed on the left side of the housing glass 5 and a right supporting portion 55 formed on the right side of the housing glass 5.

The left supporting portion 54 may comprise a left opening 54a into which the left mounting portion 74 of the second spring 7 is inserted, and a left wall 54b on which the left mounting portion 74 of the second spring 7 is caught.

The right supporting portion 55 may comprise a right opening 55a into which the right mounting portion 76 of the second spring 7 is inserted, and a right wall 55b on which the right mounting portion 76 of the second spring 7 is caught.

The housing glass 5 can be formed with a second insertion portion 56 into which the ball shaft 3 is inserted. The second insertion portion 56 can communicate with the interior of the second ball accommodation portion 22.

The second insertion portion 56 may comprise an opening formed long in the front and rear direction X on the upper part of the housing glass 5. The second insertion portion 56 may comprise an opening formed long in the vertical direction Z on the rear part of the second ball accommodation portion 52.

The width of the opening in the left and right direction may be smaller than the diameter of the second ball 34 and larger than the diameter of the shaft 36.

When the ball shaft 3 is mounted on the housing glass 5, the shaft 36 can pass through the second insertion portion 56, and the second ball 34 can be inserted into and accommodated in the second ball accommodation portion 52.

A pair of springs 6, 7 can be supported on a spring supporting portion. A pair of springs 6, 7 can press a ball 32, 34 into a ball accommodation portion 42, 45.

The spring 6, 7 may be a plate spring, and the plate spring may comprise an elastic portion and a mounting portion. The elastic portion may be in contact with the ball. The mounting portion may be bent at an end part of the elastic portion. The mounting portion may be inserted into the spring supporting portion and supported by the spring supporting portion.

The first spring 6 is supported on the spring supporting portion 44, 45 of the housing mirror 4 and can press one 32 of the pair of balls 32, 34 into the ball accommodation portion 42 of the housing mirror 4.

The first spring 6 may comprise an elastic portion 62 that comes into contact with the first ball 32 and a pair of mounting portions 64, 66 formed on the elastic portion 62.

The elastic portion 62 can press the first ball 32 forward so that a part of the outer surface of the first ball 32 comes into surface contact with the first curved surface 42a. The elastic portion 62 can press the first ball 32 against the first curved surface 42a, and a frictional force can occur between the first ball 32 and the first curved surface 42a.

A pair of mounting portions 64, 66 may comprise a left mounting portion 64 and a right mounting portion 66. A pair of mounting portions 64, 66 may be formed by bending at an end part of an elastic portion 62.

The ball accommodation portion 42 of the housing mirror 4 may be a first ball accommodation portion 42 in which the first ball 32 is accommodated, and the spring supporting portion 44, 45 of the housing mirror 4 may be a first spring supporting portion 44, 45 that supports the first spring 6.

The second spring 7 is supported on the spring supporting portion 54, 55 of the housing glass 5 and can press the other 34 of the pair of balls 32, 34 into the ball accommodation portion 52 of the housing glass 5.

The second spring 7 is supported on the spring supporting portion 54, 55 of the housing glass 5 and can press the other 34 of the pair of balls 32, 34 into the ball accommodation portion 52 of the housing glass 5.

The second spring 7 may comprise an elastic portion 72 that comes into contact with the second ball 34 and a pair of mounting portions 74, 76 formed on the elastic portion 72.

The elastic portions 72 can press the second ball 34 downward so that a part of the outer surface of the second ball 34 comes into surface contact with the second curved surface 52a. The elastic portions 72 can press the second ball 34 toward the second curved surface 52a, and a frictional force can occur between the second ball 34 and the second curved surface 42a.

A pair of mounting portions 74, 76 may comprise a left mounting portion 74 and a right mounting portion 76. A pair of mounting portions 74, 76 may be formed by bending at an end part of an elastic portion 72.

The ball accommodation portion 52 of the housing glass 5 may be a second ball accommodation portion 52 in which a second ball 34 is accommodated, and the spring supporting portion 54, 55 of the housing glass 5 may be a second spring supporting portion 54, 55 that supports a second spring 7.

One of the housing mirror 4 and the ball shaft 3 may be made of metal, and the other may be made of plastic. One of the housing glass 5 and the ball shaft 3 may be made of metal, and the other may be made of plastic.

For example, when the housing mirror 4 and the housing glass 5 are made of metal, the ball shaft 3 may be made of plastic. As another example, when the housing mirror 4 and the housing glass 5 are made of plastic, the ball shaft 3 may be made of metal.

In this case, the ball shaft 3 can rub against each of the housing mirror 4 and the housing glass 5, and the first spring 6 and the second spring 7, which are plate springs, can maintain this frictional force.

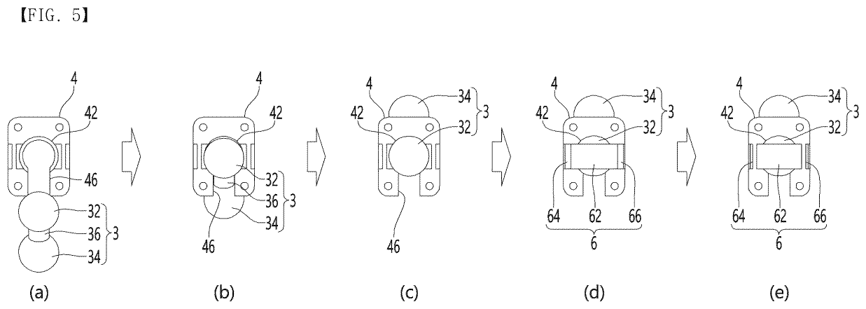

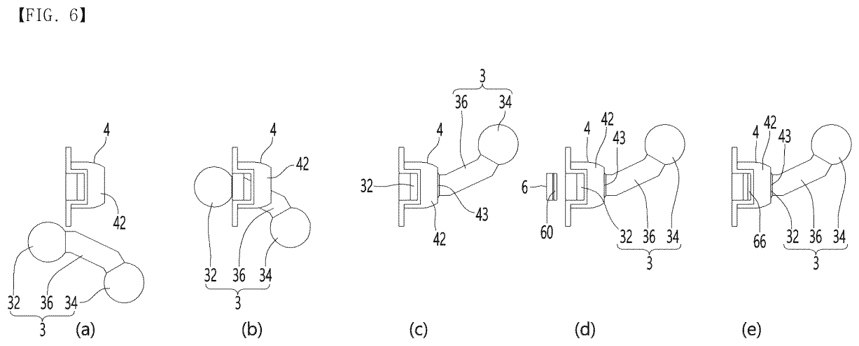

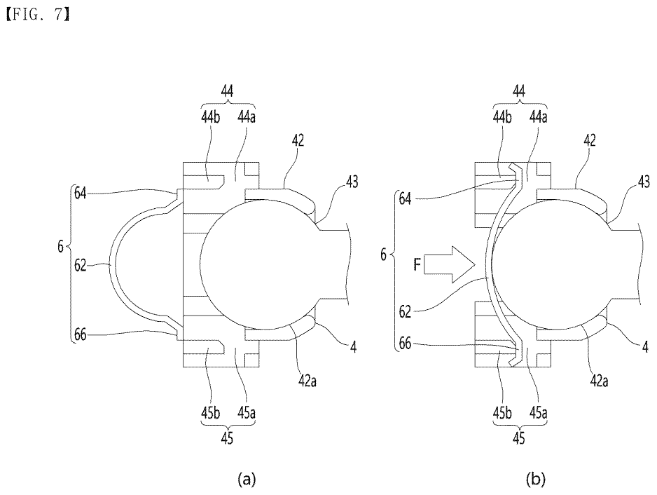

FIG. 5 is a front view illustrating the assembly process of a ball shaft and a ball housing according to the present embodiment, FIG. 6 is a side view illustrating the assembly process of the ball shaft and ball housing according to the present embodiment, and FIG. 7 is a cross-sectional view illustrating a spring mounting process according to the present embodiment.

The ball shaft 3 can be inserted into the housing mirror 4 through the insertion portion 46, and the insertion direction of the first spring 6 is configured from the outside to the inside of the housing mirror 4, so that the assembly of the mirror support can be simplified.

The ball shaft 3 can be positioned at the lower side of the housing mirror 4 as illustrated in (a) of FIG. 5 and (a) of FIG. 6 before assembly, and can be raised as illustrated in (b) of FIG. 5 and (b) of FIG. 6.

When the ball shaft 3 is raised, the shaft 36 of the ball shaft 3 can pass through the insertion portion 46 of the housing mirror 4, and the first ball 32 can be positioned at the rear of the first ball accommodation portion 42, as illustrated in (b) of FIG. 6.

In a state where the first ball 32 is positioned at the rear of the first ball accommodation portion 42 as illustrated in (b) of FIG. 6, the worker can pull the ball shaft 3 forward, and the first ball 32 can be inserted into the interior of the first ball accommodation portion 42 as illustrated in (c) of FIG. 5 and (c) of FIG. 6, and the ball shaft 3 can pass through the through-port 43 of the housing mirror 4.

Thereafter, the worker can position the first spring 6 at the rear of the first ball 32, as illustrated in (d) of FIG. 5 and (d) of FIG. 6, and deform the first spring 6 into a shape in which the elastic portion 62 is bent, as illustrated in (a) of FIG. 7. The first spring 6 can be elastically deformed so that the gap between the left mounting portion 64 and the right mounting portion 66 is smaller than the gap between the left wall 44b and the right wall 45b, as illustrated in (a) of FIG. 7.

The first spring 6 can be moved in the forward direction F as illustrated in (b) of FIG. 7, inserted between the left wall 44b and the right wall 45b, and inserted into the inside of the housing mirror 4.

The left mounting portion 64 can be inserted into the left opening 44a and restrained in the rearward direction to the left wall 44b, the right mounting portion 66 can be inserted into the right opening 45a and restrained in the rear direction to the right wall 45b, the elastic portion 62 can elastically press the first ball 42 to the first curved surface 42a, and the ball shaft 3 can be assembled to the housing mirror 4 as illustrated in (e) of FIG. 5 and (e) of FIG. 6.

The ball shaft 3 can be assembled with the housing glass 5, and the ball shaft 3 can firmly support the housing mirror 4 and the mirror 1 when assembled to the housing mirror 4 and the housing glass 5.

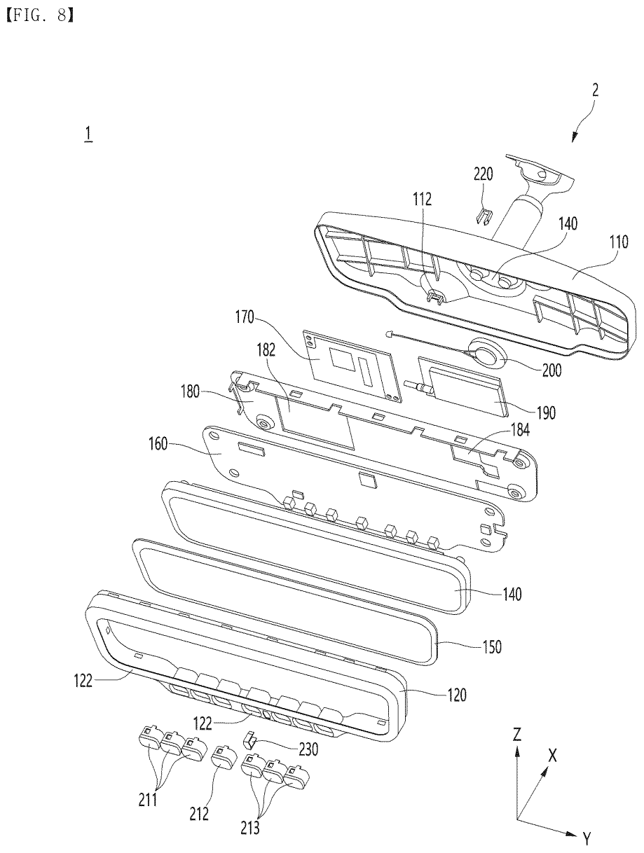

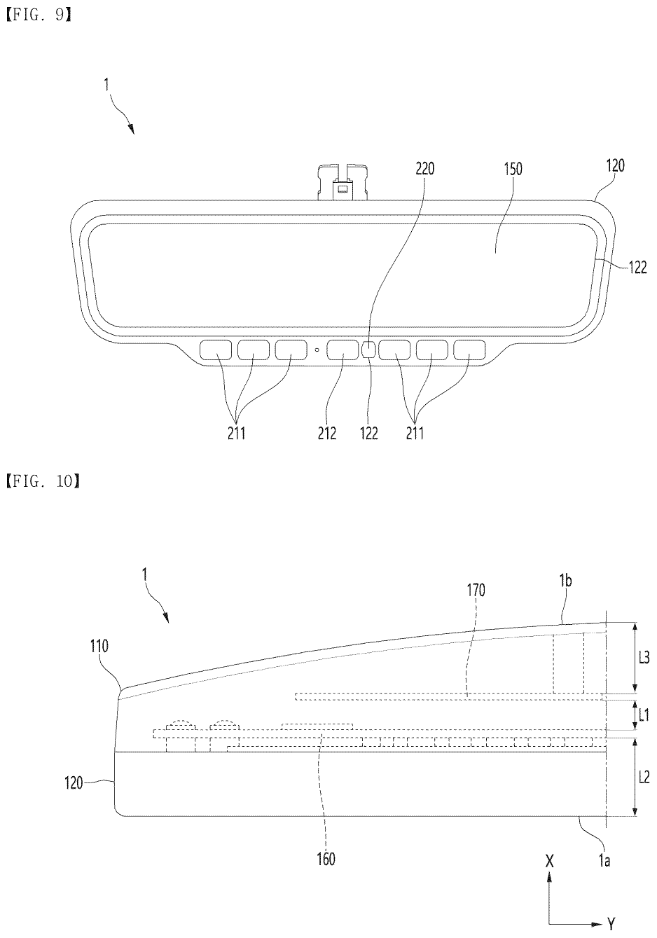

FIG. 8 is an exploded perspective view illustrating a mirror according to the present embodiment, FIG. 9 is a rear view illustrating a mirror according to the present embodiment, and FIG. 10 is a plan view illustrating the interior of a mirror according to the present embodiment.

The mirror 1 may further comprise a main-PCB 160 and a sub-PCB 170 positioned further rearward than the main-PCB 160.

The main-PCB 160 and the sub-PCB 170 can be accommodated inside the mirror housing 110 or inside the panel body 120.

The display panel 140 can be placed at the rear of the main PC 160, and the ECM 150 can be placed at the rear of the display panel 140.

The main-PCB 160 and the sub-PCB 170 can be spaced apart in the front and rear direction X.

The main-PCB 160 can be spaced apart from the front and rear ends of the mirror 1 in the front and rear directions X.

The sub-PCB 170 can be spaced from the rear end of the mirror 1 in the front and rear direction X.

The mirror 1 is preferably optimized in thickness in the front and rear direction X.

As illustrated in FIG. 10, the main-PCB 160 and the sub-PCB 170 can be spaced apart by a first distance L1, the main-PCB 160 can be spaced apart by a second distance L2 from the front end 1a of the mirror 1, and the sub-PCB 170 can be spaced apart by a third distance L3 from the rear end 1b of the mirror 1.

The first distance L1 between the main-PCB 160 and the sub-PCB 170 may be shorter than the second distance L2 between the main-PCB 160 and the front end 1a of the mirror 1, as illustrated in FIG. 10.

The first distance L1 between the main-PCB 160 and the sub-PCB 170 may be shorter than the third distance L3 between the sub-PCB 170 and the rear end 1b of the mirror 1, as illustrated in FIG. 10.

The mirror 1 may comprise a bracket 180 (see FIG. 8) on which the main-PCB 160 is mounted. The bracket 180 may be disposed inside the mirror housing 110 or inside the panel body 120. The bracket 180 may comprise a heat sink.

An opening 182 for connecting the sub-PCB 170 and the main-PCB 160 can be formed in the bracket 180.

The sub-PCB 170 can be connected to the main PC 160 by a connector such as a wire, and the connector or the sub-PCB 170 can pass through the opening 182.

The mirror 1 may further comprise a HIPASS PCB 190 and a speaker 200.

The HIPASS PCB 190 and speaker 200 can be accommodated between the bracket 180 and the mirror housing 110. The HIPASS PCB 190 can be connected to the main-PCB 160 by a connector such as a wire, and the bracket 180 can be formed with a connector opening 184 through which the connector passes.

When the mirror 1 comprises an ECM 150, a HIPASS PCB 190, and a speaker 200, the mirror 1 may be an ECM high-pass room mirror.

The mirror 1 may comprise at least one button 211, 212, 213 disposed on the panel body 120. The at least one button 211, 212, 213 may be disposed in multiple numbers on the lower part of the panel body 120, and the plurality of buttons 211, 212, 213 may be disposed in a row in the left and right direction Y.

The plurality of buttons 211, 212, 213 may comprise a home link button 211, a screen transition button 212, and a menu movement button 213.

The mirror 1 may comprise at least one illumination sensor. The at least one illumination sensor may comprise a rear illumination sensor for sensing rearward illumination, and a front illumination sensor for sensing frontward illumination.

A front illumination sensor window 220 for a front illumination sensor may be disposed in the mirror housing 110. A front mounting portion 112 on which the front illumination sensor window 220 is mounted may be formed in the mirror housing 110.

The panel body 120. A rear mounting portion 122 in which the rear illumination sensor reflector 230 is placed may be formed on the panel body 120.

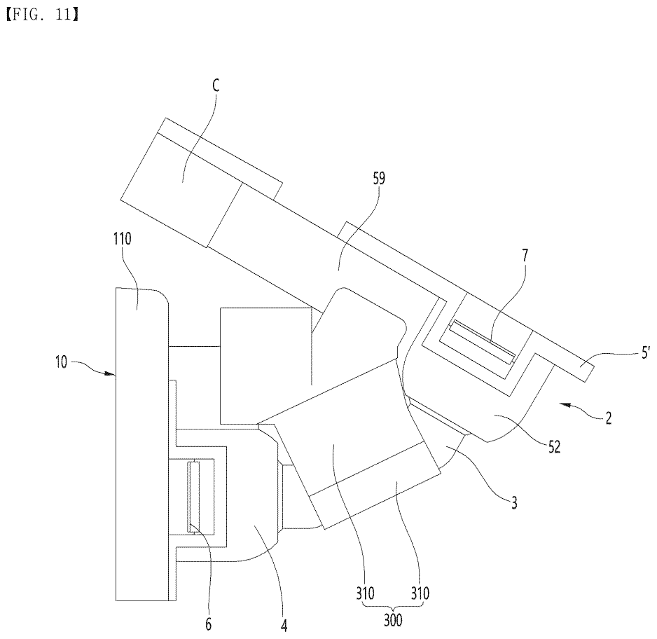

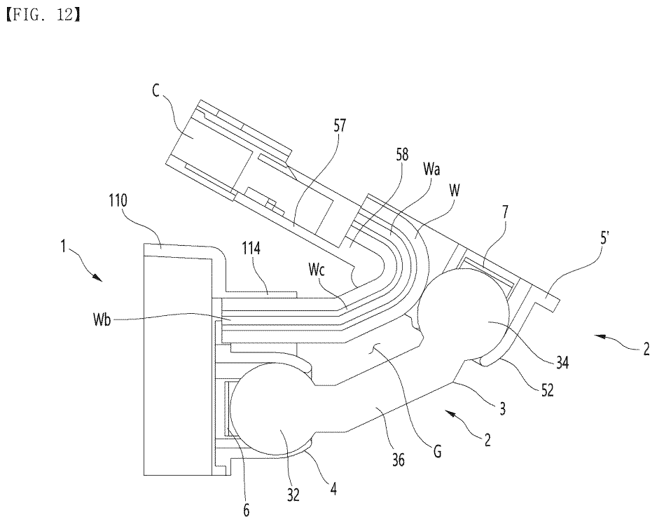

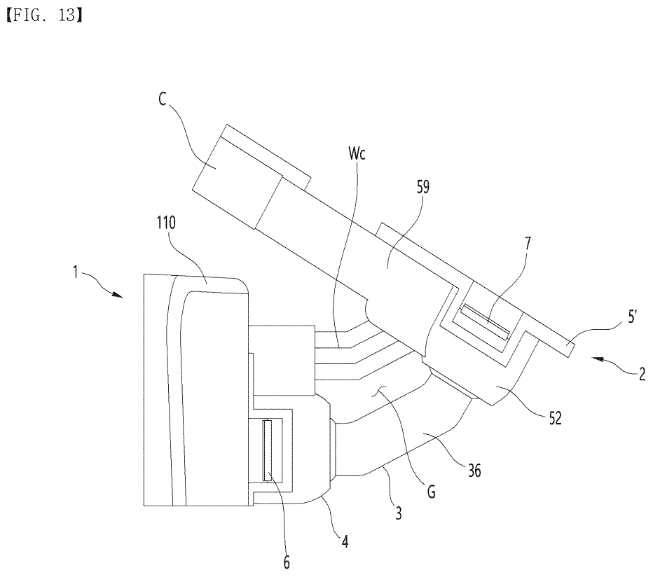

FIG. 11 is a side view illustrating another example of a mirror support according to the present embodiment, FIG. 12 is a cross-sectional view illustrating another example of a mirror support according to the present embodiment, and FIG. 13 is a side view illustrating a state where the cover illustrated in FIG. 11 is separated.

The mirror support 2′ may comprise a ball shaft 3, a housing mirror 4, a housing glass 5′, a pair of springs 6, 7, and may further comprise a cover 300 (see FIG. 11).

The ball shaft 3 may be identical or similar to the ball shaft 3 illustrated in FIGS. 3 and 4, and a detailed description thereof is omitted to avoid duplicate description.

The housing mirror 4 may be identical or similar to the housing mirror 4 illustrated in FIGS. 3 and 4, and a detailed description thereof is omitted to avoid redundant description.

A pair of springs 6, 7 may be identical to or similar to a pair of springs 6, 7 illustrated in FIGS. 3 and 4, and a detailed description thereof is omitted to avoid

### Redundant Description.

The housing glass 5′ may comprise a second ball accommodation portion 52 that accommodates a second ball 34 of the ball shaft 3, a through-part 53, a second spring supporting portion 54, 55 and an insertion portion 56 as illustrated in FIG. 4.

The housing glass 5′ may further comprise a connector fixing part 57 to which a wire connector C is fixed, as illustrated in FIG. 12, and a wire through-part 58 through which a wire W passes.

The connector fixing part 57 can be formed other than the second ball accommodation portion 52. The connector fixing part 57 can be formed on the upper part of the housing glass 5′. A wire connector C to which a wire W is connected can be inserted and mounted in the connector fixing part 57.

The wire through-part 58 can be formed inside the housing glass 5′.

The wire W can be connected at one end to a wire connector C, can pass through a wire through-part 58, and can extend inside the mirror 1, as illustrated in FIG. 12.

A cover screen 114 through which a wire W passes may be formed in the mirror housing 110 of the mirror 1. The cover screen 114 may be provided to protrude forward on the front surface of the mirror housing 110. The wire W may be fixed to the cover screen 114. The cover screen 114 may accommodate a part of the wire W.

The housing glass 5′ may further comprise a housing screen 59 that covers at least one of the connector fixing part 57 and the wire through-part 58.

The wire W can be spaced apart from the shaft 36 of the ball shaft 3 at a part Wc between the part Wa accommodated in the housing glass 5′ and the part Wb accommodated in the cover screen 114.

Hereinafter, for convenience of explanation, the part Wc between the part Wa accommodated in the housing glass 5′ of the wire W and the part Wb accommodated in the cover screen 114 is referred to as a separation portion Wc.

A gap G (see FIG. 13) can be formed between the separation portion Wc of the wire W and the shaft 36 of the ball shaft 3.

The cover 300 may be configured to cover this gap G.

The cover 300 may comprise a gap shield part 310 that shields the gap G and may further comprise a connection part 320 that connects the cover 300. The connection part 320 may be connected to one of the shaft 36 of the ball shaft 3, the housing mirror 4, and the housing glass 5′. An example of the connection part 320 may be connected to the shaft 36 of the ball shaft 3. An example of the connection part 320 may be formed to surround the shaft 36 of the ball shaft 3.

The cover 300 may be a duct that shields the gap G and through which the shaft 36 of the ball shaft 3 passes.

The description is merely an illustrative description of the technical idea of the present disclosure, and those skilled in the art will appreciate that various modifications and variations may be made without departing from the essential characteristics of the present disclosure.

Accordingly, the embodiments disclosed in the present disclosure are not intended to limit the technical idea of the present disclosure but to explain it, and the scope of the technical idea of the present disclosure is not limited by these embodiments.

The scope of protection of the present invention should be interpreted by the claims below, and all technical ideas within a scope equivalent thereto should be interpreted as being comprised in the scope of the rights of the present disclosure.

1. A mirror support comprising:
a ball shaft in which a pair of balls is connected by a shaft;
a pair of ball housings having a ball accommodation portion to accommodate the ball and having a spring supporting portion; and
a pair of springs supported on the spring supporting portion and pressing the ball into the ball accommodation portion.

2. The mirror support of claim 1,
wherein the ball housing has an insertion portion communicating with the inside of the ball accommodation portion and into which the ball shaft is inserted.

3. The mirror support of claim 1,
wherein the spring is a plate spring comprising an elastic portion that comes into contact with the ball, and a mounting portion that is bent at an end part of the elastic portion and inserted into the spring supporting portion and supported by the spring supporting portion.

4. The mirror support of claim 1,
wherein the ball accommodation portion comprises a curved surface that makes surface contact with the ball.

5. The mirror support of claim 1,
wherein the ball accommodation portion comprises a through-part through which the ball shaft passes.

6. The mirror support of claim 1,
wherein the pair of ball housings comprise:
a housing mirror coupled to a mirror; and
a housing glass attached to a glass, and
wherein the pair of springs comprise:
a first spring supported on a spring supporting portion of the housing mirror and pressurizing one of the pair of balls into the ball accommodation portion of the housing mirror; and
a second spring supported on a spring supporting portion of the housing glass and pressing the other of the pair of balls into the ball accommodation portion of the housing glass.

7. The mirror support of claim 6,
wherein one of the housing mirror and ball shaft is made of metal and the other is made of plastic.

8. The mirror support of claim 6,
wherein one of the housing glass and ball shaft is made of metal and the other is made of plastic.

9. The mirror support of claim 6, further comprising:
a wire connector disposed in the housing glass; and
a wire connected to the wire connector,
wherein the wire comprises a separation portion spaced apart from the shaft.

10. The mirror support of claim 9, further comprising:
a cover shielding a gap between the separation portion and the shaft.

11. A mirror assembly having a mirror support comprising:
a mirror, and
a mirror support supporting the mirror,
wherein the mirror support comprises:
a ball shaft in which a pair of balls is connected by a shaft;
a pair of ball housings having a ball accommodation portion to accommodate the ball and having a spring supporting portion; and
a pair of springs supported on the spring supporting portion and pressing the ball into the ball accommodation portion,
wherein the mirror comprises:
a mirror housing;
a panel body disposed in front of the mirror housing;
a display panel disposed inside the panel body; and
a fixing bracket accommodated in the mirror housing and to which one of the pair of ball housings is fastened.

12. The mirror support of claim 11,
wherein the ball housing has an insertion portion communicating with the inside of the ball accommodation portion and into which the ball shaft is inserted.

13. The mirror support of claim 11,
wherein the spring is a plate spring comprising an elastic portion that comes into contact with the ball, and a mounting portion that is bent at an end part of the elastic portion and inserted into the spring supporting portion and supported by the spring supporting portion.

14. The mirror support of claim 11,
wherein the ball accommodation portion comprises a curved surface that makes surface contact with the ball.

15. The mirror support of claim 11,
wherein the ball accommodation portion comprises a through-part through which the ball shaft passes.

16. The mirror support of claim 11,
wherein the pair of ball housings comprise:
a housing mirror coupled to a mirror; and
a housing glass attached to the glass, and
wherein the pair of springs comprise:
a first spring supported on a spring supporting portion of the housing mirror and pressurizing one of the pair of balls into the ball accommodation portion of the housing mirror; and
a second spring supported on a spring supporting portion of the housing glass and pressing the other of the pair of balls into the ball accommodation portion of the housing glass.

17. The mirror support of claim 11,
wherein one of the housing mirror and ball shaft is made of metal and the other is made of plastic.

18. The mirror support of claim 11,
wherein one of the housing glass and ball shaft is made of metal and the other is made of plastic.

19. The mirror assembly having a mirror support of claim 11,
wherein the mirror comprises:
a main-PCB; and
a sub-PCB disposed at the rear of the main-PCB, and
wherein a first distance between the main-PCB and the sub-PCB is shorter than a second distance between the main PC and a front end of the mirror.

20. The mirror assembly having a mirror support of claim 19,
wherein the first distance of the mirror is shorter than a third distance between the sub-PCB and a rear end of the mirror.
